(19) United States
(12) Patent Application Publication
(10) Pub. No.: US 2025/0201455 A1
(43) Pub. Date: Jun. 19, 2025

(54) High temperature resistant magnet and a preparation method thereof

(71) Applicant: Yantai Dongxing Magnetic Materials Inc., Yantai, Shandong (CN)

(72) Inventors: Chuanshen WANG, Yantai, Shandong (CN); Zhongjie PENG, Yantai, Shandong (CN); Kunkun YANG, Yantai, Shandong (CN); Kaihong DING, Yantai, Shandong (CN)

(21) Appl. No.: 17/951,138

(22) Filed: Sep. 23, 2022

(30) Foreign Application Priority Data
Sep. 24, 2021 (CN) 202111120165.9

(51) Int. Cl. H01F 1/057; B22F 3/04; B22F 3/10; B22F 3/24; B22F 9/02; B22F 9/04; B22F 9/08; C22C 38/00; C22C 38/06; C22C 38/10; C22C 38/16; H01F 41/02

(52) U.S. Cl. CPC H01F 1/0577; B22F 3/04; B22F 3/10; B22F 3/24; B22F 9/023; B22F 9/04; B22F 9/08; C22C 38/002; C22C 38/005; C22C 38/06; C22C 38/10; C22C 38/16; H01F 41/0293; B22F 2003/241; B22F 2003/248; B22F 2009/041; B22F 2009/044; B22F 2202/05; B22F 2301/355; B22F 2998/10; B22F 2999/00; C22C 2202/02

(57) ABSTRACT

The disclosure relates to the technical field of sintered type NdFeB permanent magnets, in particular to a high temperature resistant magnet. There is provided a preparation method for the magnet including a step of preparing a mixture of the NdFeB alloy flakes and a low melting point powder, wherein the low melting point powder comprises at least one of NdCu, NdAl and NdGa.

This application is based on Chinese Patent Application No. 202111120165.9, filed Sep. 24, 2021, which claims the benefit of priority to the Chinese Patent Application, which is incorporated by reference in its entirety herein.

### TECHNICAL FIELD

The disclosure relates to the technical field of sintered type NdFeB permanent magnets, in particular to a high temperature resistant magnet.

### BACKGROUND

NdFeB sintered permanent magnets are widely used in high-tech fields such as electronic information, medical equipment, new energy vehicles, household appliances, robots, etc. In the past few decades of development, NdFeB permanent magnets have been rapidly developed, and the residual magnetic properties have basically reached the theoretical limit. However, the gap between the coercive force and the theoretical value is still very large, so improving the coercive force of the magnet is a major research hotspot.

At present, the remanence of NdFeB products can reach about 90% of the theoretical saturation magnetization of Nd₂Fe₁₄B, but the coercivity is still difficult to reach one third of the theoretical value without addition of heavy rare earth elements. Substitution of heavy rare earth elements can significantly improve coercivity of neodymium iron boron magnets. However, heavy rare earths are expensive and have fewer resources. In order to reduce the cost of raw materials and reduce the usage of heavy rare earth, optimizing the manufacturing process should be taken into consideration.

For improving the magnetic characteristics, Tb or Dy may be directly added to the composition for forming the magnet. However, such an approach consumes large amounts of Tb or Dy, which significantly increases the manufacturing costs. Although the content of heavy rare earths can be greatly reduced by the grain boundary diffusion technology, the costs are still very high with the current soaring price of heavy rare earth elements Tb or Dy. Therefore, it is still important to continuously reduce the content of these heavy rare earth elements.

Meanwhile, heavy rare earth alloys with low melting points as a diffusion source to achieve high coercivity magnets have been developed. CN112735717A discloses magnets coated with heavy rare earth Tb and Dy by diffusion and that aging can further improve the coercivity. CN105513734A shows that magnetic performance is enhanced by diffusion of light and heavy rare earth mixtures. But the homogeneity of the mixture is insufficient, so it is not suitable as a diffusion source. In addition, the high-temperature resistance of the magnet is poor, i.e. the residual magnetism and coercivity are low at high temperatures.

Therefore, it is desirable to find a diffusion source that allows a high diffusion depth but also improves the high temperature resistance of the magnet.

### SUMMARY

In order to overcome at least some of the deficiencies present in the prior art, the present disclosure provides a high temperature resistant magnet and a method of making thereof.

According to a first aspect of the present disclosure, there is provided a method of preparing a high temperature resistant NdFeB magnet as defined in claim 1. The method comprises the following steps:
(S1) Preparing NdFeB alloy flakes from a raw material of the NdFeB magnet by strip casting;
(S2) Preparing a mixture of the NdFeB alloy flakes and a low melting point powder, then performing a hydrogen decrepitation of the mixture followed by jet milling to obtain a NdFeB powder, wherein the low melting point powder comprises at least one of NdCu, NdAl and NdGa;
(S3) cold isostatic pressing the alloy powder to a green compact while applying a magnetic field;
(S4) sintering the green compact to obtain a NdFeB magnet; and
(S5) applying a heavy rare earth diffusion material on the surface of the NdFeB magnet and performing a thermal diffusion process to obtain the high-temperature-resistant NdFeB magnet.

According to another aspect of the present disclosure, a high temperature resistant magnet is provided, which is obtained by the above-mentioned method.

Compared with the prior art, the present disclosure has at least the following beneficial effects:

A grain boundary magnet with a low melting point is provided and thus only low amounts of heavy rare earth material is required for the diffusion process. A low-heavy rare earth NdFeB magnet with specific grain boundary structure is obtained by diffusion and, if necessary, aging treatment. The coercivity of the magnet is greatly improved. The coercivity increase after diffusion Dy alloy can reach 636.8-835.8 kA/m.

The magnet has high temperature resistance, overcoming the shortcomings of common low melting point magnets having poor high temperature resistance.

The diffusion magnet matrix contains NdCu, NdAl and NdGa of the low melting point phase, which is assumed to increasing the diffusion coefficient of the magnet grain boundary, thereby improving the diffusion efficiency of the diffusion source.

The diffusion source not only enables the low melting point phase and the heavy rare earth to enter the magnet at the same time, can greatly improve the high temperature resistance of the magnet, but also can form a shell with magnetic isolation effect, thereby improving the coercivity.

Further aspects of the disclosure could be learned from the dependent claims and the following description.

### BRIEF DESCRIPTION OF THE DRAWINGS

FIG. 1 shows a schematic diagram of test sample with SEM using ZISS electron microscopy (SEM images of the microstructure of Nd—Fe—B permanent magnets after diffusion using backscattered electron (BSE) contrast).

### DETAILED DESCRIPTION OF THE EMBODIMENTS

Reference will now be made in detail to embodiments. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

### General Concept

A method of preparing a high temperature resistant NdFeB magnet comprises the following steps:
(S1) Preparing NdFeB alloy flakes from a raw material of the NdFeB magnet by strip casting;
(S2) Preparing a mixture of the NdFeB alloy flakes and a low melting point powder, then performing a hydrogen decrepitation of the mixture followed by jet milling to obtain a NdFeB powder, wherein the low melting point powder comprises at least one of NdCu, NdAl and NdGa;
(S3) cold isostatic pressing the alloy powder to a green compact while applying a magnetic field;
(S4) sintering the green compact to obtain a NdFeB magnet; and
(S5) applying a heavy rare earth diffusion material on the surface of the NdFeB magnet and performing a thermal diffusion process to obtain the high-temperature-resistant NdFeB magnet.

In step (S2), the total weight content of Cu, Al and Ga in the mixture may be in the range of 0.1 to 3.0 wt. %, preferably 0.4 to 1.5 wt. %. Preferably, in step (S2), the weight content of Al in the mixture is in the range of 0.2 to 1.0 wt. %, the weight content of Cu in the mixture is in the range of 0.1 to 0.5 wt. %, and the weight content of Ga in the mixture is in the range of 0.05 to 0.4 wt. %.

The low melting point powder may have an average particle size D50 in the range of 200 nm to 4 μm. The average particle diameter (D50) of the particles may be measured by laser diffraction (LD). The method may be performed according to ISO 13320-1. According to the IUPAC definition, the equivalent diameter of a non-spherical particle is equal to a diameter of a spherical particle that exhibits identical properties to that of the investigated non-spherical particle.

A NdFeB magnet (also known as NIB or Neo magnet) is the most widely used type of rare-earth magnet. It is a permanent magnet made from an alloy of neodymium, iron, and boron to form the Nd₂Fe₁₄B tetragonal crystalline structure as a main phase. Besides, the microstructure of Nd—Fe—B magnets includes usually a Nd-rich phase. The alloy may include further elements in addition to or partly substituting neodymium and iron.

In step (S1), the alloy raw material may be composed of [symbol] , 0.8%≤B≤1.2%, 0%≤M≤3% in weight percentages, the remainder is Fe, R including at least two elements of Nd, Pr, Ce, La, Tb, Dy, Ho, and Gd; and M including at least one element of Co, Mg, Ti, Zr, and Nb.

In step (S2), the dehydrogenation temperature may be 400-600° C.

In step (S3), the sintering temperature may be 980-1060° C. for 6-15 h.

In step (S3), after the sintering a primary aging treatment and secondary aging treatment may be performed.

In step (S4), the composition of the heavy rare earth diffusion source film may be R1ₓR2_{y}H_{z}M_{1-x-y-z}, wherein R1 is at least one of Nd and Pr, the weight percentage of R1 is 15%<x<50%, R2 is at least one of Ho and Gd, the weight percentage of R2 is 0%<y≤10%, H is at least one of Tb and Dy, the weight percentage of H is 40%≤z≤70%, M is at least one of Al, Cu, Ga, Ti, Co, Mg, Zn, and Sn, the weight percentage of M is 1-x-y-z.

In step (S5), the diffusion temperature of NdFeB magnets may be 850-930° C. and the diffusion time is 6-30 h.

A high temperature resistant magnet can be obtained by the above-mentioned method.

The grain boundary structure of the magnet may comprise a main phase structure, an R shell, a transition metal shell and a triangular region. The R shell is at least one of Nd, Pr, Ho, and Gd. The transition metal shell layer is at least one of Cu, Al, and Ga. The triangular zone or region may comprise at least one of Component I, Component I, and Component III.

Component I is NdₐFe_{b}R_{c}M_{d}, with R including at least one element of Pr, Ce, and La and M including at least three elements of Al, Cu, Ga, Ti, Co, Mg, Zn, Sn and Zr. The weight percentage of Nd is 30%≤a≤70%, the weight percentage of Fe is 5%≤b≤40%, the weight percentage of R is 5%≤c≤35%, and the weight percentage of M is 0≤d≤15%.

Component II is NdₑFe_{f}R_{g}HₕKᵢMⱼ, with R including at least one element of Pr, Ce, and La, H including at least one element of Dy and Tb, K including at least one element of Ho and Gd, and M including at least three elements of Al, Cu, Ga, Ti, Co, Mg, Zn, Sn and Zr. The weight percentage of Nd is e, 25%≤e≤65%, the weight percentage of Fe is f, 5%≤f≤35%, the weight percentage of R is g, 5%≤g≤30%, the weight percentage of H is h, 5%≤h≤30%, the weight percentage of K is i, 1%≤i≤12%, and the weight percentage of M is j, 0%≤j≤10%.

Component III is NdₖFeₗRₘDₙMₒ, with R including at least one element of Pr, Ce, and La, D including at least one element of Al, Cu, Ga, and M including at least one element of Ti, Co, Mg, Zn, Sn, and Zr. The weight percentage of Nd is k, 30%≤k≤70%, the weight percentage of Fe is l, 5%≤l≤35%, the weight percentage of R is m, 5%≤m≤35%, the weight percentage of D is n, 5%≤n≤25%, and the weight percentage of M is o, 0%≤o≤10%.

Furthermore, a thickness of magnet may be 0.3-6 mm.

A method of preparing the high temperature resistant magnet, may be performed in the following exemplary way:
(S1) The prepared NdFeB alloy raw materials are smelted to obtain strip casting NdFeB alloy sheets, and the alloy sheets are mechanically crushed and crushed into flake alloy sheets of 150-400 μm;
(S2) The flake alloy sheets, low melting point powders and lubricant for mechanical mixing and stirring are put into a hydrogen treatment furnace for hydrogen absorption and dehydrogenation treatment, then NdFeB powders are obtained by jet milling. The NdFeB powder particle size is 3-5 μm;
(S3) The above NdFeB powders are pressed and formed, and sintered to obtain the desired NdFeB magnet;
(S4) The sintered NdFeB magnet is mechanically processed to make the desired shape, and then a low-heavy rare earth diffusion source film is formed on the surface of the magnet, wherein the diffusion source may be present in the form of atomized powders;
(S5) Finally, the structure of above characteristics of NdFeB magnets are prepared by diffusion and aging;

Preferably, in step (S1), the NdFeB alloy raw material compositions of weight percentage are, respectively, 28%≤R≤30%, 0.8%≤B≤1.2%, 0%≤M≤3%, the rest is Fe, the R including at least two elements of Nd, Pr, Ce, La, Tb, Dy, Ho, Gd, the M including at least one element of Co, Mg, Ti, Zr, Nb.

Preferably, in step (S2), the low melting point powder comprises at least one of NdCu, NdAl and NdGa, and its weight percentage is 0%≤NdCu≤3%, 0%≤NdAl≤3%, 0%≤NdGa≤3%, and the size of low melting point powders is 200 nm-4 μm.

Preferably, in step (S3), after sintering, the magnet cooled in an argon stream, and then a primary aging treatment and secondary aging treatment is carried out. The sintering temperature is 980-1060° C., and the sintering time is 6-15 h. The first-level aging temperature is 850° C., and the first-level aging time is 3 h. The second-stage aging temperature is 450-660° C., and the second-stage aging time is 3 h.

Preferably, in step (S5), the diffusion temperature of NdFeB magnets is 850-930° C., the diffusion time is 6-30 h, the aging temperature is 420-680° C., and the aging time is 3-10 h. Preferably, the aging temperature of the NdFeB magnet is heated at a rate of 1-5° C./min, and the cooling rate is 5-20° C./min.

To have a better understanding of the present disclosure, the examples set forth below provide illustrations of the present disclosure. The examples are only used to illustrate the present disclosure and do not limit the scope of the present disclosure.

### Examples

In the following, the present disclosure is described according to some embodiments and a corresponding manufacturing method.

The method of manufacturing a high-temperature-resistant magnet comprises the following steps:
(S1) The NdFeB alloy raw materials are smelted to obtain NdFeB alloy sheets by strip casting, and then the alloy sheets are mechanically crushed into alloy flakes with a particle size of about 150-400 μm.
(S2) The alloy flakes, low melting point powders containing NdCu, NdAl and NdGa, and lubricants are mechanically mixed and stirred, and numbered as 1 to 22 according to their magnet composition as shown in Table 1. Then the mixture is put into a hydrogen treatment furnace for hydrogen absorption and dehydrogenation treatment, wherein the dehydrogenation temperature is at about 400-600° C. NdFeB powders are prepared by jet milling and the NdFeB powder particle size is 3-5 μm.

The alloy powders after the air flow grinding is oriented molding and pressed into the blank by isostatic pressure. The pressing blank is sintered in vacuum, and quickly cooled with argon, and then a primary aging treatment and a secondary aging treatment are carried out, the magnets performance is tested. The process conditions and magnet characteristics are summarized in Table 2.

The sintered NdFeB magnet is mechanically processed to make the desired shape, and then a low-heavy rare earth diffusion source film is formed on the surface of the magnet. Finally, NdFeB magnets are prepared by diffusion and aging processing.

The diffusion sources contained Ho or Gd. Each process condition of the embodiment is shown in Table 3, correspondingly, the proportional process conditions are shown in Table 4. Table 3 shows diffusion sources, process conditions and properties.

TABLE 1
Magnet composition of alloy flakes, low
melting point powder and lubricant mixed.

| | Magnet composition | | | | | |
|---|---|---|---|---|---|---|
| No. | Al | B | Co | Cu | Fe | Ga |
| 1 | 0.30% | 0.97% | 1.00% | 0.15% | Margin | 0.05% |
| 2 | 0.59% | 0.95% | 1.00% | 0.15% | Margin | 0.11% |
| 3 | 0.87% | 0.93% | 1.00% | 0.14% | Margin | 0.21% |
| 4 | 0.83% | 0.95% | 1.00% | 0.29% | Margin | 0.05% |
| 5 | 0.41% | 0.92% | 1.00% | 0.29% | Margin | 0.10% |
| 6 | 0.53% | 0.95% | 1.00% | 0.29% | Margin | 0.21% |
| 7 | 0.82% | 0.94% | 1.00% | 0.44% | Margin | 0.05% |
| 8 | 0.53% | 0.95% | 1.00% | 0.44% | Margin | 0.11% |
| 9 | 0.35% | 0.92% | 1.00% | 0.43% | Margin | 0.21% |
| 10 | 0.42% | 0.97% | 1.00% | 0.15% | Margin | 0.11% |
| 11 | 0.59% | 0.94% | 1.00% | 0.15% | Margin | 0.21% |
| 12 | 0.86% | 0.92% | 1.00% | 0.14% | Margin | 0.31% |
| 13 | 0.82% | 0.94% | 1.00% | 0.29% | Margin | 0.11% |
| 14 | 0.41% | 0.91% | 1.00% | 0.29% | Margin | 0.21% |
| 15 | 0.53% | 0.94% | 1.00% | 0.29% | Margin | 0.32% |
| 16 | 0.81% | 0.94% | 1.00% | 0.43% | Margin | 0.11% |
| 17 | 0.53% | 0.94% | 1.00% | 0.44% | Margin | 0.21% |
| 18 | 0.35% | 0.91% | 1.00% | 0.43% | Margin | 0.31% |
| 19 | 0.31% | 0.97% | 0.91% | 0.20% | Margin | 0.18% |
| 20 | 0.70% | 1.00% | 1.00% | 0.15% | Margin | 0.20% |
| 21 | 0.34% | 0.91% | 1.00% | 0.15% | Margin | 0.20% |
| 22 | 0.28% | 0.87% | 0.80% | 0.38% | Margin | 0.37% |

| | Magnet composition | | | | |
|---|---|---|---|---|---|
| No. | Nd | Pr | Ti | Ho | TRE |
| 1 | 29.52% | \ | \ | \ | 29.52% |
| 2 | 31.23% | \ | \ | \ | 31.23% |
| 3 | 33.19% | \ | \ | \ | 33.19% |
| 4 | 31.51% | \ | \ | \ | 31.51% |
| 5 | 26.35% | 6.59% | 0.05% | \ | 32.94% |
| 6 | 24.81% | 6.20% | 0.05% | \ | 31.02% |
| 7 | 25.61% | 6.40% | 0.05% | \ | 32.02% |
| 8 | 24.74% | 6.19% | 0.06% | \ | 30.93% |
| 9 | 26.19% | 6.55% | 0.05% | \ | 32.73% |
| 10 | 23.89% | 5.97% | 0.10% | \ | 29.86% |
| 11 | 31.82% | \ | 0.10% | \ | 31.82% |
| 12 | 33.76% | \ | 0.10% | \ | 33.76% |
| 13 | 23.86% | 7.95% | 0.10% | \ | 31.81% |
| 14 | 25.14% | 8.38% | 0.10% | \ | 33.52% |
| 15 | 23.71% | 7.90% | 0.20% | \ | 31.61% |
| 16 | 32.31% | \ | 0.20% | \ | 32.31% |
| 17 | 31.52% | \ | 0.20% | \ | 31.52% |
| 18 | 33.31% | \ | 0.20% | \ | 33.31% |
| 19 | 24.83% | 6.39% | 0.20% | \ | 31.22% |
| 20 | 25.00% | 6.20% | 0.10% | \ | 31.20% |
| 21 | 22.00% | 5.50% | 0.15% | 3.37% | 30.87% |
| 22 | 23.62% | 7.60% | 0.10% | \ | 31.22% |

TABLE 2
Process conditions of the magnet.

| | Sintering | holding | One-level | holding | Secondary | holding |
|---|---|---|---|---|---|---|
| | temp | time | aging | time | aging | time |
| No | ° C. | h | ° C. | h | ° C. | h |
| 1 | 980 | 15 | 850 | 3 | 450 | 3 |
| 2 | 980 | 15 | 850 | 3 | 450 | 3 |
| 3 | 980 | 15 | 850 | 3 | 450 | 3 |
| 4 | 980 | 15 | 850 | 3 | 450 | 3 |
| 5 | 980 | 15 | 850 | 3 | 480 | 3 |
| 6 | 1020 | 13 | 850 | 3 | 480 | 3 |
| 7 | 1020 | 13 | 850 | 3 | 480 | 3 |
| 8 | 1020 | 13 | 850 | 3 | 480 | 3 |
| 9 | 1020 | 13 | 850 | 3 | 510 | 3 |
| 10 | 1020 | 13 | 850 | 3 | 510 | 3 |
| 11 | 1040 | 9 | 850 | 3 | 510 | 3 |
| 12 | 1040 | 9 | 850 | 3 | 510 | 3 |
| 13 | 1040 | 9 | 850 | 3 | 550 | 3 |
| 14 | 1040 | 9 | 850 | 3 | 550 | 3 |
| 15 | 1040 | 9 | 850 | 3 | 550 | 3 |
| 16 | 1060 | 6 | 850 | 3 | 550 | 3 |
| 17 | 1060 | 6 | 850 | 3 | 580 | 3 |
| 18 | 1060 | 6 | 850 | 3 | 580 | 3 |
| 19 | 1060 | 6 | 850 | 3 | 580 | 3 |
| 20 | 1060 | 6 | 850 | 3 | 660 | 3 |
| 21 | 1050 | 12 | 850 | 3 | 660 | 3 |
| 22 | 1060 | 7 | 850 | 3 | 660 | 3 |

| | Heating | Cooling | Performance | | |
|---|---|---|---|---|---|
| | rate | rate | Br | Hcj | Hk/ |
| No | ° C./min | ° C./min | (T) | (kA/m) | Hcj |
| 1 | 5 | 5 | 1.455 | 1137.48 | 0.99 |
| 2 | 5 | 5 | 1.386 | 1330.91 | 0.99 |
| 3 | 5 | 10 | 1.317 | 1545.83 | 0.97 |
| 4 | 5 | 15 | 1.356 | 1391.41 | 0.98 |
| 5 | 3 | 15 | 1.367 | 1312.60 | 0.98 |
| 6 | 1 | 5 | 1.393 | 1328.52 | 0.98 |
| 7 | 1 | 20 | 1.347 | 1407.33 | 0.97 |
| 8 | 3 | 20 | 1.396 | 1285.54 | 0.97 |
| 9 | 3 | 20 | 1.374 | 1325.34 | 0.98 |
| 10 | 3 | 10 | 1.432 | 1203.55 | 0.98 |
| 11 | 1 | 10 | 1.371 | 1373.90 | 0.97 |
| 12 | 1 | 10 | 1.302 | 1584.04 | 0.98 |
| 13 | 5 | 10 | 1.345 | 1504.44 | 0.98 |
| 14 | 5 | 15 | 1.352 | 1373.10 | 0.98 |
| 15 | 5 | 15 | 1.377 | 1394.59 | 0.98 |
| 16 | 3 | 20 | 1.338 | 1437.58 | 0.97 |
| 17 | 1 | 20 | 1.380 | 1347.63 | 0.97 |
| 18 | 3 | 20 | 1.358 | 1385.04 | 0.98 |
| 19 | 3 | 5 | 1.370 | 1472.60 | 0.98 |
| 20 | 1 | 5 | 1.340 | 1512.40 | 0.98 |
| 21 | 1 | 5 | 1.330 | 1432.80 | 0.99 |
| 22 | 1 | 15 | 1.360 | 1592.00 | 0.99 |

TABLE 3
Diffusion sources of embodiments and their process conditions and magnet properties.

| | | | Diffusion | holding | Aging | holding |
|---|---|---|---|---|---|---|
| Ex- | Diffusion | Size | Temp | time | Temp | time |
| ample | Source | mm | ° C. | hours | ° C. | hours |
| 1 | PrHoDyCu | 10 × 10 × 3 | 850 | 30 | 420 | 10 |
| 2 | PrHoDyCu | 10 × 10 × 3 | 850 | 30 | 480 | 7 |
| 3 | PrHoDyCu | 10 × 10 × 3 | 850 | 30 | 500 | 5 |
| 4 | PrHoDyCu | 10 × 10 × 3 | 880 | 20 | 450 | 8 |
| 5 | NdHoDyCu | 10 × 10 × 4 | 880 | 20 | 500 | 6 |
| 6 | NdHoDyCu | 10 × 10 × 4 | 880 | 20 | 600 | 5 |
| 7 | NdHoDyCu | 10 × 10 × 4 | 880 | 20 | 500 | 3 |
| 8 | PrGdDyCu | 10 × 10 × 4 | 900 | 15 | 450 | 8 |
| 9 | PrGdDyCu | 10 × 10 × 5 | 900 | 16 | 500 | 6 |
| 10 | PrGdDyCu | 10 × 10 × 5 | 900 | 17 | 520 | 4 |
| 11 | PrGdDyCu | 10 × 10 × 5 | 900 | 18 | 600 | 5 |
| 12 | PrGdDyCu | 10 × 10 × 5 | 900 | 19 | 500 | 3 |
| 13 | PrHoDyCuGa | 10 × 10 × 3 | 910 | 10 | 450 | 8 |
| 14 | PrHoDyCuGa | 10 × 10 × 3 | 910 | 10 | 500 | 6 |
| 15 | PrHoDyCuGa | 10 × 10 × 3 | 910 | 10 | 520 | 4 |
| 16 | PrHoDyCuAl | 10 × 10 × 3 | 910 | 10 | 450 | 5 |
| 17 | PrHoDyCuAl | 10 × 10 × 3 | 910 | 10 | 480 | 3 |
| 18 | PrHoDyCuAl | 10 × 10 × 3 | 930 | 6 | 450 | 8 |
| 19 | PrGdDyCu | 10 × 10 × 4 | 930 | 6 | 500 | 6 |
| 20 | PrGdDyCu | 10 × 10 × 4 | 930 | 6 | 520 | 4 |
| 21 | PrGdDyCu | 10 × 10 × 4 | 930 | 6 | 600 | 5 |
| 22 | PrGdDyCu | 10 × 10 × 4 | 930 | 6 | 680 | 3 |

| | | Heating | Cooling | Performance after Diffusion | | | |
|---|---|---|---|---|---|---|---|
| Ex- | Diffusion | rate | rate | Br | Hcj | Hk/ | βHcj |
| ample | Source | ° C./min | ° C./min | (T) | (kA/m) | Hcj | 150° C. |
| 1 | PrHoDyCu | 5 | 5 | 1.432 | 1982.04 | 0.97 | −0.500% |
| 2 | PrHoDyCu | 5 | 5 | 1.36 | 2053.68 | 0.97 | −0.495% |
| 3 | PrHoDyCu | 5 | 10 | 1.293 | 2189.00 | 0.96 | −0.450% |
| 4 | PrHoDyCu | 5 | 15 | 1.33 | 2029.80 | 0.96 | −0.497% |
| 5 | NdHoDyCu | 3 | 15 | 1.34 | 2117.36 | 0.96 | −0.490% |
| 6 | NdHoDyCu | 1 | 5 | 1.368 | 2021.84 | 0.97 | −0.492% |
| 7 | NdHoDyCu | 1 | 20 | 1.323 | 2149.20 | 0.96 | −0.482% |
| 8 | PrGdDyCu | 3 | 20 | 1.37 | 2069.60 | 0.96 | −0.490% |
| 9 | PrGdDyCu | 3 | 20 | 1.35 | 2101.44 | 0.97 | −0.470% |
| 10 | PrGdDyCu | 3 | 10 | 1.405 | 2069.60 | 0.97 | −0.480% |
| 11 | PrGdDyCu | 1 | 10 | 1.35 | 2029.80 | 0.97 | −0.490% |
| 12 | PrGdDyCu | 1 | 10 | 1.275 | 2228.80 | 0.97 | −0.457% |
| 13 | PrHoDyCuGa | 5 | 10 | 1.32 | 2133.28 | 0.96 | −0.460% |
| 14 | PrHoDyCuGa | 5 | 15 | 1.325 | 2077.56 | 0.97 | −0.470% |
| 15 | PrHoDyCuGa | 5 | 15 | 1.35 | 2149.20 | 0.97 | −0.460% |
| 16 | PrHoDyCuAl | 3 | 20 | 1.312 | 2189.00 | 0.97 | −0.470% |
| 17 | PrHoDyCuAl | 1 | 20 | 1.36 | 2045.72 | 0.96 | −0.480% |
| 18 | PrHoDyCuAl | 3 | 20 | 1.33 | 2109.40 | 0.98 | −0.490% |
| 19 | PrGdDyCu | 3 | 5 | 1.34 | 2196.96 | 0.97 | −0.470% |
| 20 | PrGdDyCu | 3 | 5 | 1.32 | 2125.32 | 0.97 | −0.475% |
| 21 | PrGdDyCu | 1 | 5 | 1.305 | 2212.88 | 0.98 | −0.460% |
| 22 | PrGdDyCu | 1 | 15 | 1.338 | 2220.84 | 0.98 | −0.455% |

TABLE 4
Diffusion sources of counter-proportionality and their process conditions and properties.

| | | | Diffusion | holding | Aging | holding |
|---|---|---|---|---|---|---|
| propor- | Diffusion | Size | Temp | time | Temp | time |
| tionality | Source | mm | ° C. | hours | ° C. | hours |
| 1 | PrDyCu | 10 × 10 × 3 | 850 | 30 | 420 | 10 |
| 2 | PrDyCu | 10 × 10 × 3 | 850 | 30 | 480 | 7 |
| 3 | PrDyCu | 10 × 10 × 3 | 850 | 30 | 500 | 5 |
| 4 | PrDyCu | 10 × 10 × 3 | 880 | 20 | 450 | 8 |
| 5 | NdDyCu | 10 × 10 × 4 | 880 | 20 | 500 | 6 |
| 6 | NdDyCu | 10 × 10 × 4 | 880 | 20 | 600 | 5 |
| 7 | NdDyCu | 10 × 10 × 4 | 880 | 20 | 500 | 3 |
| 8 | PrDyCu | 10 × 10 × 4 | 900 | 15 | 450 | 8 |
| 9 | PrDyCu | 10 × 10 × 5 | 900 | 16 | 500 | 6 |
| 10 | PrDyCu | 10 × 10 × 5 | 900 | 17 | 520 | 4 |
| 11 | PrDyCu | 10 × 10 × 5 | 900 | 18 | 600 | 5 |
| 12 | PrDyCu | 10 × 10 × 5 | 900 | 19 | 500 | 3 |
| 13 | PrDyCuGa | 10 × 10 × 3 | 910 | 10 | 450 | 8 |
| 14 | PrDyCuGa | 10 × 10 × 3 | 910 | 10 | 500 | 6 |
| 15 | PrDyCuGa | 10 × 10 × 3 | 910 | 10 | 520 | 4 |
| 16 | PrDyCuAl | 10 × 10 × 3 | 910 | 10 | 450 | 5 |
| 17 | PrDyCuAl | 10 × 10 × 3 | 910 | 10 | 480 | 3 |
| 18 | PrDyCuAl | 10 × 10 × 3 | 930 | 6 | 450 | 8 |
| 19 | PrDyCu | 10 × 10 × 4 | 930 | 6 | 500 | 6 |
| 20 | PrDyCu | 10 × 10 × 4 | 930 | 6 | 520 | 4 |
| 21 | PrDyCu | 10 × 10 × 4 | 930 | 6 | 600 | 5 |
| 22 | PrDyCu | 10 × 10 × 4 | 930 | 6 | 680 | 3 |

| | | Heating | Cooling | Performance after Diffusion | | | |
|---|---|---|---|---|---|---|---|
| propor- | Diffusion | rate | rate | Br | Hcj | Hk/ | βHcj |
| tionality | Source | ° C./min | ° C./min | (T) | (kA/m) | Hcj | 150° C. |
| 1 | PrDyCu | 5 | 5 | 1.435 | 1950.20 | 0.97 | −0.530% |
| 2 | PrDyCu | 5 | 5 | 1.362 | 2029.80 | 0.97 | −0.510% |
| 3 | PrDyCu | 5 | 10 | 1.295 | 2149.20 | 0.96 | −0.510% |
| 4 | PrDyCu | 5 | 15 | 1.332 | 1990.00 | 0.96 | −0.520% |
| 5 | NdDyCu | 3 | 15 | 1.342 | 2069.60 | 0.96 | −0.510% |
| 6 | NdDyCu | 1 | 5 | 1.37 | 1990.00 | 0.97 | −0.520% |
| 7 | NdDyCu | 1 | 20 | 1.325 | 2109.40 | 0.96 | −0.515% |
| 8 | PrDyCu | 3 | 20 | 1.375 | 2029.80 | 0.96 | −0.510% |
| 9 | PrDyCu | 3 | 20 | 1.35 | 2069.60 | 0.97 | −0.500% |
| 10 | PrDyCu | 3 | 10 | 1.41 | 1990.00 | 0.97 | −0.515% |
| 11 | PrDyCu | 1 | 10 | 1.35 | 1990.00 | 0.97 | −0.525% |
| 12 | PrDyCu | 1 | 10 | 1.28 | 2189.00 | 0.97 | −0.510% |
| 13 | PrDyCuGa | 5 | 10 | 1.32 | 2109.40 | 0.96 | −0.510% |
| 14 | PrDyCuGa | 5 | 15 | 1.33 | 2029.80 | 0.97 | −0.520% |
| 15 | PrDyCuGa | 5 | 15 | 1.352 | 2109.40 | 0.97 | −0.505% |
| 16 | PrDyCuAl | 3 | 20 | 1.315 | 2149.20 | 0.97 | −0.510% |
| 17 | PrDyCuAl | 1 | 20 | 1.36 | 1990.00 | 0.96 | −0.520% |
| 18 | PrDyCuAl | 3 | 20 | 1.332 | 2069.60 | 0.98 | −0.505% |
| 19 | PrDyCu | 3 | 5 | 1.345 | 2149.20 | 0.97 | −0.495% |
| 20 | PrDyCu | 3 | 5 | 1.32 | 2109.40 | 0.97 | −0.500% |
| 21 | PrDyCu | 1 | 5 | 1.305 | 2189.00 | 0.98 | −0.510% |
| 22 | PrDyCu | 1 | 15 | 1.34 | 2189.00 | 0.98 | −0.510% |

Based on the above data, the NdCu or NdAl or NdGa phase powders are added to the grain boundary of the NdFeB alloy flakes, whose grain boundary has a low melting point. The grain boundary channel of NdFeB permanent magnets are suitable for the diffusion especially the diffusion source of heavy rare earth Dy alloys. The coercivity is increased significantly get ΔHcj>597 kA/m after diffusion, and the high temperature coefficient of coercivity is significantly better than the proportionality.

Example 1: The performance of example 1 by diffusion PrHoDyCu decreased by 0.023 T of Br, increased by 844.6 kA/m of Hcj, and the coefficient of high temperature resistance of the magnet's 150° C. coercivity was −0.50% compared with the pre-diffusion performance of NdFeB magnet. The performance of the proportional 1 by diffusion PrDyCu decreased by 0.02 T, of Br, increased by 812.7 kA/m of Hcj, and the coefficient of high temperature resistance of the magnet's 150° C. coercivity was −0.53%. The advantages of Example 1 are obvious.

Example 2: The same NdFeB magnet and size, the same diffusion temperature and aging temperature, etc., the performance of example 2 by diffusion PrHoDyCu decreased by 0.026 T of Br, increased by 722.8 kA/m of Hcj, and the coefficient of high temperature resistance of the magnet's 150° C. coercivity was −0.495% compared with the pre-diffusion performance of NdFeB magnet. The performance of the proportional 2 by diffusion PrDyCu decreased by 0.024 T of Br, increased by 698.9 kA/m of Hcj, and the coefficient of high temperature resistance of the magnet's 150° C. coercivity was −0.51%. The advantages of Example 2 are obvious.

Example 3: The same NdFeB magnet and size, the same diffusion temperature and aging temperature, etc., the performance of example 3 by diffusion PrHoDyCu decreased by 0.024 T of Br, increased by 643.2 kA/m of Hcj, and the coefficient of high temperature resistance of the magnet's 150° C. coercivity was −0.45% compared with the pre-diffusion performance of NdFeB magnet. The performance of the proportional 3 by diffusion PrDyCu decreased by 0.022 T of Br, increased by 603.4 kA/m of Hcj, and the coefficient of high temperature resistance of the magnet's 150° C. coercivity was −0.51%. The advantages of Example 3 are obvious.

Example 4: The same NdFeB magnet and size, the same diffusion temperature and aging temperature, etc., the performance of example 4 by diffusion PrHoDyCu decreased by 0.026 T of Br, increased by 638.4 kA/m of Hcj, and the coefficient of high temperature resistance of the magnet's 150° C. coercivity was −0.497% compared with the pre-diffusion performance of NdFeB magnet. The performance of the proportional 4 by diffusion PrDyCu decreased by 0.024 T of Br, increased by 598.6 kA/m of Hcj, and the coefficient of high temperature resistance of the magnet's 150° C. coercivity was −0.52%. The advantages of Example 4 are obvious.

Example 5: The same NdFeB magnet and size, the same diffusion temperature and aging temperature, etc., the performance of example 5 by diffusion NdHoDyCu decreased by 0.027 T of Br, increased by 804.7 kA/m of Hcj, and the coefficient of high temperature resistance of the magnet's 150° C. coercivity was −0.49% compared with the pre-diffusion performance of NdFeB magnet. The performance of the proportional 5 by diffusion NdDyCu decreased by 0.025 T of Br, increased by 757 kA/m of Hcj, and the coefficient of high temperature resistance of the magnet's 150° C. coercivity was −0.51%. The advantages of Example 5 are obvious.

Example 6: The same NdFeB magnet and size, the same diffusion temperature and aging temperature, etc., the performance of example 6 by diffusion NdHoDyCu decreased by 0.025 T of Br, increased by 693.3 kA/m of Hcj, and the coefficient of high temperature resistance of the magnet's 150° C. coercivity was −0.492% compared with the pre-diffusion performance of NdFeB magnet. The performance of the proportional 6 by diffusion NdDyCu decreased by 0.023 T of Br, increased by 661.5 kA/m of Hcj, and the coefficient of high temperature resistance of the magnet's 150° C. coercivity was −0.52%. The advantages of Example 6 are obvious.

Example 7: The same NdFeB magnet and size, the same diffusion temperature and aging temperature, etc., the performance of example 7 by diffusion NdHoDyCu decreased by 0.024 T of Br, increased by 741.9 kA/m of Hcj, and the coefficient of high temperature resistance of the magnet's 150° C. coercivity was −0.482% compared with the pre-diffusion performance of NdFeB magnet. The performance of the proportional 7 by diffusion NdDyCu decreased by 0.022 T of Br, increased by 702.1 kA/m of Hcj, and the coefficient of high temperature resistance of the magnet's 150° C. coercivity was −0.515%. The advantages of Example 7 are obvious.

Example 8: The same NdFeB magnet and size, the same diffusion temperature and aging temperature, etc., the performance of example 8 by diffusion PrGdDyCu decreased by 0.026 T of Br, increased by 784.06 kA/m of Hcj, and the coefficient of high temperature resistance of the magnet's 150° C. coercivity was −0.49% compared with the pre-diffusion performance of NdFeB magnet. The performance of the proportional 8 by diffusion PrDyCu decreased by 0.021 T of Br, increased by 744.3 kA/m of Hcj, and the coefficient of high temperature resistance of the magnet's 150° C. coercivity was −0.51%. The advantages of Example 8 are obvious.

Example 9: The same NdFeB magnet and size, the same diffusion temperature and aging temperature, etc., the performance of example 9 by diffusion PrGdDyCu decreased by 0.024 T of Br, increased by 776.1 kA/m of Hcj, and the coefficient of high temperature resistance of the magnet's 150° C. coercivity was −0.47% compared with the pre-diffusion performance of NdFeB magnet. The performance of the proportional 9 by diffusion PrDyCu decreased by 0.024 T of Br, increased by 744.26 kA/m of Hcj, and the coefficient of high temperature resistance of the magnet's 150° C. coercivity was −0.5%. The advantages of Example 9 are obvious.

Example 10: The same NdFeB magnet and size, the same diffusion temperature and aging temperature, etc., the performance of example 10 by diffusion PrGdDyCu decreased by 0.027 T of Br, increased by 866.05 kA/m of Hcj, and the coefficient of high temperature resistance of the magnet's 150° C. coercivity was −0.48% compared with the pre-diffusion performance of NdFeB magnet. The performance of the proportional 10 by diffusion PrDyCu decreased by 0.022 T of Br, increased by 786.45 kA/m of Hcj, and the coefficient of high temperature resistance of the magnet's 150° C. coercivity was −0.515%. The advantages of Example 10 are obvious.

Example 11: The same NdFeB magnet and size, the same diffusion temperature and aging temperature, etc., the performance of example 11 by diffusion PrGdDyCu decreased by 0.021 T of Br, increased by 655.9 kA/m of Hcj, and the coefficient of high temperature resistance of the magnet's 150° C. coercivity was −0.49% compared with the pre-diffusion performance of NdFeB magnet. The performance of the proportional 11 by diffusion PrDyCu decreased by 0.021 T of Br, increased by 616.1 kA/m of Hcj, and the coefficient of high temperature resistance of the magnet's 150° C. coercivity was −0.525%. The advantages of Example 11 are obvious.

Example 12: The same NdFeB magnet and size, the same diffusion temperature and aging temperature, etc., the performance of example 12 by diffusion PrGdDyCu decreased by 0.027 T of Br, increased by 644.76 kA/m of Hcj, and the coefficient of high temperature resistance of the magnet's 150° C. coercivity was −0.457% compared with the pre-diffusion performance of NdFeB magnet. The performance of the proportional 12 by diffusion PrDyCu decreased by 0.022 T of Br, increased by 604.96 kOe of Hcj, and the coefficient of high temperature resistance of the magnet's 150° C. coercivity was −0.51%. The advantages of Example 12 are obvious.

Example 13: The same NdFeB magnet and size, the same diffusion temperature and aging temperature, etc., the performance of example 13 by diffusion PrHoDyCuGa decreased by 0.025 T of Br, increased by 628.84 kA/m of Hcj, and the coefficient of high temperature resistance of the magnet's 150° C. coercivity was −0.46% compared with the pre-diffusion performance of NdFeB magnet. The performance of the proportional 13 by diffusion PrDyCuGa decreased by 0.025 T of Br, increased by 604.96 kA/m of Hcj, and the coefficient of high temperature resistance of the magnet's 150° C. coercivity was −0.51%. The advantages of Example 13 are obvious.

Example 14: The same NdFeB magnet and size, the same diffusion temperature and aging temperature, etc., the performance of example 14 by diffusion PrHoDyCuGa decreased by 0.027 T of Br, increased by 704.46 kA/m of Hcj, and the coefficient of high temperature resistance of the magnet's 150° C. coercivity was −0.47% compared with the pre-diffusion performance of NdFeB magnet. The performance of the proportional 14 by diffusion PrDyCuGa decreased by 0.022 T of Br, increased by 656.7 kA/m of Hcj, and the coefficient of high temperature resistance of the magnet's 150° C. coercivity was −0.52%. The advantages of Example 14 are obvious.

Example 15: The same NdFeB magnet and size, the same diffusion temperature and aging temperature, etc., the performance of example 15 by diffusion PrHoDyCuGa decreased by 0.027 T of Br, increased by 754.61 kA/m of Hcj, and the coefficient of high temperature resistance of the magnet's 150° C. coercivity was −0.46% compared with the pre-diffusion performance of NdFeB magnet. The performance of the proportional 15 by diffusion PrDyCuGa decreased by 0.025 T of Br, increased by 714.8 kA/m of Hcj, and the coefficient of high temperature resistance of the magnet's 150° C. coercivity was −0.505%. The advantages of Example 15 are obvious.

Example 16: The same NdFeB magnet and size, the same diffusion temperature and aging temperature, etc., the performance of example 16 by diffusion PrHoDyCuAl decreased by 0.026 T of Br, increased by 751.4 kA/m of Hcj, and the coefficient of high temperature resistance of the magnet's 150° C. coercivity was −0.47% compared with the pre-diffusion performance of NdFeB magnet. The performance of the proportional 16 by diffusion PrDyCuAl decreased by 0.02 T of Br, increased by 812.7 kA/m of Hcj, and the coefficient of high temperature resistance of the magnet's 150° C. coercivity was −0.51%. The advantages of Example 16 are obvious.

Example 17: The same NdFeB magnet and size, the same diffusion temperature and aging temperature, etc., the performance of example 17 by diffusion PrHoDyCuAl decreased by 0.02 T of Br, increased by 698.1 kA/m of Hcj, and the coefficient of high temperature resistance of the magnet's 150° C. coercivity was −0.48% compared with the pre-diffusion performance of NdFeB magnet. The performance of the proportional 17 by diffusion PrDyCuAl decreased by 0.02 T of Br, increased by 812.7 kA/m of Hcj, and the coefficient of high temperature resistance of the magnet's 150° C. coercivity was −0.52%. The advantages of Example 17 are obvious.

Example 18: The same NdFeB magnet and size, the same diffusion temperature and aging temperature, etc., the performance of example 18 by diffusion PrHoDyCuAl decreased by 0.028 T of Br, increased by 724.4 kA/m of Hcj, and the coefficient of high temperature resistance of the magnet's 150° C. coercivity was −0.49% compared with the pre-diffusion performance of NdFeB magnet. The performance of the proportional 18 by diffusion PrDyCuAl decreased by 0.026 T of Br, increased by 684.56 kA/m of Hcj, and the coefficient of high temperature resistance of the magnet's 150° C. coercivity was −0.505%. The advantages of Example 18 are obvious.

Example 19: The same NdFeB magnet and size, the same diffusion temperature and aging temperature, etc., the performance of example 19 by diffusion PrGdDyCu decreased by 0.03 T of Br, increased by 724.36 kA/m of Hcj, and the coefficient of high temperature resistance of the magnet's 150° C. coercivity was −0.47% compared with the pre-diffusion performance of NdFeB magnet. The performance of the proportional 19 by diffusion PrDyCu decreased by 0.02 T of Br, increased by 812.7 kA/m of Hcj, and the coefficient of high temperature resistance of the magnet's 150° C. coercivity was −0.53%. The advantages of Example 19 are obvious.

Example 20: The same NdFeB magnet and size, the same diffusion temperature and aging temperature, etc., the performance of example 20 by diffusion PrGdDyCu decreased by 0.02 T of Br, increased by 612.92 kA/m of Hcj, and the coefficient of high temperature resistance of the magnet's 150° C. coercivity was −0.475% compared with the pre-diffusion performance of NdFeB magnet. The performance of the proportional 20 by diffusion PrDyCu decreased by 0.02 T of Br, increased by 597 kA/m of Hcj, and the coefficient of high temperature resistance of the magnet's 150° C. coercivity was −0.5%. The advantages of Example 20 are obvious.

Example 21: The same NdFeB magnet and size, the same diffusion temperature and aging temperature, etc., the performance of example 21 by diffusion PrGdDyCu decreased by 0.025 T of Br, increased by 780.08 kA/m of Hcj, and the coefficient of high temperature resistance of the magnet's 150° C. coercivity was −0.46% compared with the pre-diffusion performance of NdFeB magnet. The performance of the proportional 21 by diffusion PrDyCu decreased by 0.025 T of Br, increased by 756.2 kA/m of Hcj, and the coefficient of high temperature resistance of the magnet's 150° C. coercivity was −0.51%. The advantages of Example 21 are obvious.

Example 22: The same NdFeB magnet and size, the same diffusion temperature and aging temperature, etc., the performance of example 22 by diffusion PrGdDyCu decreased by 0.022 T of Br, increased by 628.84 kA/m of Hcj, and the coefficient of high temperature resistance of the magnet's 150° C. coercivity was −0.455% compared with the pre-diffusion performance of NdFeB magnet. The performance of the proportional 22 by diffusion PrDyCu decreased by 0.02 T of Br, increased by 597 kA/m of Hcj, and the coefficient of high temperature resistance of the magnet's 150° C. coercivity was −0.51%. The advantages of Example 22 are obvious.

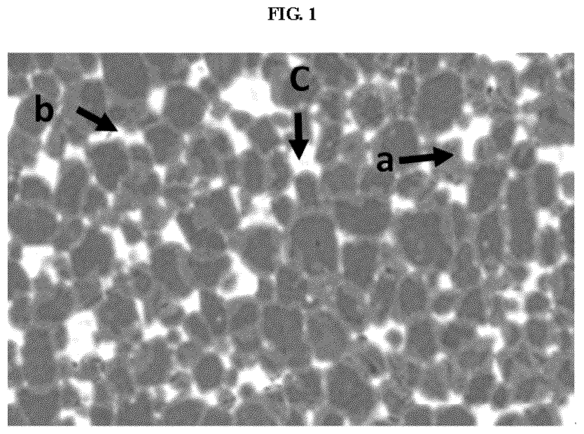

From the above, it can be seen that the high temperature resistance effect of example after diffusion is significantly better than the high temperature resistance of the proportional example. Therefore, the magnets after diffusion of heavy rare earth alloys were subjected to microstructure determination. The tests were mainly carried out using ZISS electron microscopy for SEM and Oxford EDS for the elemental composition of the sample magnets. It was found that the rare earth shell (i.e. the R shell) is more than 60% around the grain and the transition metal shell is more than 40% around the grain. In addition, three points a, b, and c of the SEM sample are sampling points at different locations and the range of sampling points summarized as Component I, Component II, Component III, respectively. However, the small triangle area with a size <1 μm is characterized by a 6:14 Cu rich phase type, that is, the chemical formula of EDS is: Fe₃₀₋₅₁(NdPr)₄₅₋₆₀Cu₂₋₁₅Ga₀₋₅Co₀₋₅ or Fe₃₀₋₅₁(NdPr)₄₅₋₆₀Dy₂₋₁₅Cu₂₋₁₅Ga₀₋₅Co₀₋₅ (weight percentage of the elements). The three points a, b, and c are shown in FIG. 1. The R shell and the transition metal shell, the three points a, b, and c are statistically analyzed as follows:

In Example 1, after diffusion with PrHoDyCu the magnet has the following microstructure: Pr, Dy, Ho rare earth shell and transition metal shell Cu, and the formation of sampling composition 1: Nd₅₀₋₇₀Fe₁₀₋₃₀Pr₁₀₋₂₀Cu₀₋₅, sampling component 2: Nd₅₀₋₅₅Fe₁₀₋₃₀Pr₅₋₁₅Dy₅₋₁₅Ho₂₋₉Cu₀₋₅, sampling composition 3: Nd₅₀₋₇₀Fe₁₀₋₃₅Pr₁₀₋₂₀Cu₁₀₋₂₀Co₀₋₅.

Example 2, after diffusion with PrHoDyCu the magnet has the following microstructure: Pr, Dy, Ho rare earth shell and transition metal shell Cu, and the formation of sampling composition 1: Nd₅₀₋₆₅Fe₁₀₋₃₀Pr₁₀₋₂₅Cu₀₋₅Ga₀₋₅Al₀₋₃, sampling component 2: Nd₅₀₋₅₅Fe₁₀₋₃₀Pr₅₋₁₅Dy₅₋₁₅Ho₃₋₁₀Cu₀₋₅, sampling composition 3: Nd₅₀₋₇₀Fe₁₀₋₃₅Pr₁₀₋₂₀Cu₁₀₋₁₅Co₀₋₅.

Example 3, after diffusion with PrHoDyCu the magnet has the following microstructure: Pr, Dy, Ho rare earth shell and transition metal shell Cu, and the formation of sampling composition 1: Nd₄₅₋₆₅Fe₁₀₋₃₅Pr₁₀₋₂₅Cu₀₋₅Ga₀₋₅Al₃₋₅, sampling component 2: Nd₄₅₋₅₅Fe₁₀₋₃₀Pr₅₋₂₀Dy₅₋₁₀Ho₃₋₈Cu₀₋₅, sampling composition 3: Nd₅₀₋₆₅Fe₁₀₋₃₅Pr₁₀₋₂₀Cu₁₀₋₁₅Co₀₋₅Al₀₋₅.

Example 4, after diffusion with PrHoDyCu the magnet has the following microstructure: Pr, Dy, Ho rare earth shell and transition metal shell Cu and Al, and the formation of sampling composition 1: Nd₄₅₋₆₀Fe₁₀₋₃₅Pr₁₀₋₂₀Cu₃₋₈Ga₀₋₅Al₃₋₅, sampling component 2: Nd₄₅₋₅₅Fe₁₀₋₃₀Pr₅₋₂₀Dy₅₋₁₀Ho₃₋₆Cu₂₋₅Al₂₋₁₀, sampling composition 3: Nd₄₅₋₆₅Fe₁₀₋₃₀Pr₁₀₋₂₀Cu₁₀₋₂₅Co₀₋₅Al₀₋₅.

Example 5, after diffusion with NdHoDyCu the magnet has the following microstructure: Nd, Dy, Ho rare earth shell and transition metal shell Cu, and the formation of sampling composition 1: Nd₅₀₋₆₅Pr₁₀₋₁₅Fe₁₀₋₃₀Cu₂₋₆Go₀₋₅, sampling component 2: Nd₄₅₋₆₀Fe₅₋₃₀Pr₅₋₁₅Dy₅₋₁₅Ho₃₋₁₀, sampling composition 3: Nd₄₅₋₆₀Pr₁₀₋₂₀Fe₅₋₃₀Cu₁₀₋₂₀Co₀₋₅.

Example 6, after diffusion with NdHoDyCu the magnet has the following microstructure: Nd, Dy, Ho rare earth shell and transition metal shell Cu, and the formation of sampling composition 1: Nd₄₅₋₆₀Pr₁₀₋₂₀Fe₁₀₋₃₀Cu₂₋₅Ga₀₋₅, sampling component 2: Nd₄₅₋₆₀Fe₅₋₂₅Pr₅₋₁₂Dy₅₋₂₀Ho₂₋₉, sampling composition 3: Nd₅₀₋₆₀Pr₁₀₋₁₅Fe₅₋₂₅Cu₅₋₂₅Co₀₋₅.

Example 7, after diffusion with NdHoDyCu the magnet has the following microstructure: Nd, Dy, Ho rare earth shell and transition metal shell Cu and Al, and the formation of sampling composition 1: Nd₅₀₋₆₅Pr₁₀₋₁₅Fe₁₀₋₄₀Cu₅₋₁₀Al₀₋₅, sampling component 2: Nd₅₀₋₆₀Fe₅₋₃₀Pr₅₋₁₅Dy₅₋₂₅Ho₃₋₁₂Al₂₋₁₀, sampling composition 3: Nd₅₀₋₆₀Pr₁₀₋₁₅Fe₅₋₂₅Cu₅₋₁₅Co₀₋₅Al₀₋₅.

Example 8, after diffusion with PrGdDyCu the magnet has the following microstructure: Pr, Dy, Gd rare earth shell and transition metal shell Cu, and the formation of sampling composition 1: Nd₄₀₋₆₅Pr₂₀₋₃₅Fe₁₀₋₂₅Cu₅₋₁₀, sampling component 2: Nd₂₅₋₄₀Fe₁₀₋₃₀Pr₁₀₋₂₅Dy₁₅₋₂₀Gd₁₋₇Co₀₋₅Cu₀₋₅, sampling composition 3: Nd₃₅₋₄₅Pr₁₅₋₃₅Fe₅₋₂₅Cu₁₀₋₂₅Co₀₋₅.

Example 9, after diffusion with PrGdDyCu the magnet has the following microstructure: Pr, Dy, Gd rare earth shell and transition metal shell Cu, and the formation of sampling composition 1: Nd₄₀₋₆₀Pr₂₀₋₃₀Fe₁₀₋₃₀Cu₃₋₈, sampling component 2: Nd₃₅₋₄₅Fe₁₀₋₃₀Pr₁₀₋₂₅Dy₅₋₂₅Gd₂₋₁₂Co₀₋₅Cu₀₋₅, sampling composition 3: Nd₃₅₋₅₀Pr₁₅₋₃₀Fe₅₋₂₅Cu₅₋₂₀Co₀₋₅.

Example 10, after diffusion with PrGdDyCu the magnet has the following microstructure: Pr, Dy, Gd rare earth shell and transition metal shell Cu, and the formation of sampling composition 1: Nd₄₀₋₆₀Pr₂₀₋₃₅Fe₁₀₋₃₀Cu₀₋₅, sampling component 2: Nd₂₅₋₄₀Fe₁₀₋₃₀Pr₁₀₋₂₅Dy₅₋₁₅Gd₂₋₇Co₀₋₅Cu₀₋₅, sampling composition 3: Nd₃₅₋₄₅Pr₁₅₋₃₅Fe₅₋₃₀Cu₅₋₂₀Co₀₋₅.

Example 11, after diffusion with PrGdDyCu the magnet has the following microstructure: Pr, Dy, Gd rare earth shell and transition metal shell Cu, and the formation of sampling composition 1: Nd₅₀₋₆₅Fe₁₀₋₂₅Pr₁₀₋₂₀Cu₀₋₅Ga₀₋₅Al₀₋₅, sampling component 2: Nd₄₅₋₅₅Fe₁₀₋₃₀Pr₅₋₂₀Dy₅₋₂₀Gd₃₋₉Cu₀₋₅, sampling composition 3: Nd₄₅₋₇₀Fe₁₀₋₃₀Pr₁₀₋₂₅Cu₁₀₋₂₅Co₀₋₅Ga₀₋₅.

Example 12, after diffusion with PrGdDyCu the magnet has the following microstructure: Pr, Dy, Gd rare earth shell and transition metal shell Cu, and the formation of sampling composition 1: Nd₅₀₋₆₅Fe₁₀₋₃₀Pr₁₀₋₂₅Cu₀₋₅Ga₂-7Al₃₋₇, sampling component 2: Nd₄₅₋₅₅Fe₁₀₋₃₀Pr₅₋₂₀Dy₅₋₁₀Gd₂₋₅Cu₀₋₅Ga₀₋₅, sampling composition 3: Nd₅₀₋₆₅Fe₁₀₋₃₅Pr₅₋₂₀Cu₁₀₋₂₀Co₀₋₅Al₀₋₅.

Example 13, after diffusion with PrHoDyCuGa the magnet has the following microstructure: Pr, Dy, Ho rare earth shell and transition metal shell Cu and Ga, and the formation of sampling composition 1: Nd₄₅₋₅₅Pr₂₀₋₂₅Fe₁₅₋₃₀Ga₂₋₁₀Cu₃₋₅, sampling component 2: Nd₃₀₋₄₅Fe₅₋₂₅Pr₂₅₋₃₀Dy₅₋₂₀Ho₁₋₁₀Cu₀₋₅, sampling composition 3: Nd₃₅₋₄₅Pr₂₀₋₃₅Fe₁₀₋₃₅Cu₅₋₁₅Ga₅₋₁₀Co₂₋₅.

Example 14, after diffusion with PrHoDyCuGa the magnet has the following microstructure: Pr, Dy, Ho rare earth shell and transition metal shell Cu and Ga, and the formation of sampling composition 1: Nd₄₀₋₅₅Pr₂₀₋₃₀Fe₁₅₋₃₀Ga₂₋₁₀Cu₃₋₅, sampling component 2: Nd₃₀₋₄₀Fe₅₋₂₅Pr₂₅₋₃₀Dy₅₋₁₅Ho₂₋₉Cu₀₋₅, sampling composition 3: Nd₃₀₋₅₀Pr₂₅₋₃₀Fe₁₀₋₃₀Cu₅₋₁₀Ga₅₋₁₀Co₂₋₅.

Example 15, after diffusion with PrHoDyCuGa the magnet has the following microstructure: Pr, Dy, Ho rare earth shell and transition metal shell Cu and Ga, and the formation of sampling composition 1: Nd₄₀₋₅₅Pr₂₀₋₃₀Fe₁₅₋₂₅Ga₅₋₁₀Cu₃₋₁₀, component 2: sampling Nd₃₀₋₄₀Fe₅₋₂₅Pr₁₅₋₃₀Dy₅₋₂₀Ho₃₋₁₂Cu₀₋₅, sampling composition 3: Nd₃₀₋₄₅Pr₂₅₋₃₅Fe₁₀₋₃₀Cu₅₋₁₀Ga₅₋₁₀Co₂₋₅.

Example 16, after diffusion with PrHoDyCuAl the magnet has the following microstructure: Pr, Dy, Ho rare earth shell and transition metal shell Cu and Al, and the formation of sampling composition 1: Nd₄₅₋₆₅Fe₁₀₋₃₅Pr₅₋₁₅Cu₅₋₁₅Al₅₋₁₀, sampling component 2: Nd₄₅₋₆₅Fe₅₋₃₀Pr₅₋₂₀Dy₅₋₁₀Ho₂₋₁₁Cu₅₋₁₀Al₂₋₁₀, sampling composition 3: Nd₅₀₋₆₅Fe₁₀₋₂₀Pr₁₀₋₁₅Cu₁₀₋₂₅Al₀₋₅.

Example 17, after diffusion with PrHoDyCuAl the magnet has the following microstructure: Pr, Dy, Ho rare earth shell and transition metal shell Cu and Al, and the formation of sampling composition 1: Nd₄₅₋₅₅Fe₁₀₋₃₀Pr₅₋₂₀Cu₅₋₁₀Al₂₋₅, sampling component 2: Nd₄₅₋₆₀Fe₅₋₂₅Pr₅₋₂₅Dy₅₋₁₅Ho₂₋₁₀Cu₅₋₁₀Al₃₋₅, sampling composition 3: Nd₄₅₋₆₀Fe₁₀₋₂₀Pr₁₀₋₂₀Cu₁₀₋₂₀Ga₀₋₅Al₀₋₅.

Example 18, after diffusion with PrHoDyCuAl the magnet has the following microstructure: Pr, Dy, Ho rare earth shell and transition metal shell Cu and Al, and the formation of sampling composition 1: Nd₅₀₋₆₅Fe₁₀₋₃₀Pr₅₋₂₀Cu₅₋₁₀Al₂₋₅, sampling component 2: Nd₄₅₋₆₀Fe₁₀₋₂₅Pr₁₀₋₂₀Cu₁₀₋₂₀Ga₀₋₅Al₀₋₅, sampling composition 3: Nd₄₅₋₆₅Fe₅₋₃₀Pr₅₋₂₀Dy₅₋₁₅Ho₁₋₆Cu₅₋₁₀Al₅₋₁₀.

Example 19, after diffusion with PrGdDyCu the magnet has the following microstructure: Pr, Dy, Gd rare earth shell and transition metal shell Cu, and the formation of sampling composition 1: Nd₄₅₋₅₅Fe₅₋₃₀Pr₂₀₋₃₅Cu₀₋₅, sampling component 2: Nd₄₅₋₅₅Fe₅₋₁₀Pr₁₀₋₃₀Dy₅₋₂₀Gd₂₋₈Cu₀₋₅, sampling composition 3: Nd₃₅₋₅₅Fe₅₋₃₀Pr₁₀₋₃₅Cu₅₋₁₀Ga₀₋₅Co₀₋₅.

Example 20, after diffusion with PrGdDyCu the magnet has the following microstructure: Pr, Dy, Gd rare earth shell and transition metal shell Cu, and the formation of sampling composition 1: Nd₃₅₋₅₀Fe₁₅₋₄₀Pr₁₅₋₃₀Cu₀₋₁₀Ga₀₋₃Al₀₋₃, sampling component 2: Nd₄₀₋₆₀Fe₃₋₃₀Pr₁₀₋₂₀Gd₁₋₇Dy₅₋₂₅, sampling composition 3: Nd₄₀₋₅₅Fe₅₋₃₅Pr₁₅₋₃₀Cu₅₋₂₅Ga₀₋₅Co₀₋₅.

Example 21, after diffusion with PrGdDyCu the magnet has the following microstructure: Pr, Dy, Gd rare earth shell and transition metal shell Cu, and the formation of sampling composition 1: Nd₃₀₋₄₅Fe₁₀₋₃₀Pr₂₀₋₂₅Cu₅₋₁₀Ga₀₋₅Co₀₋₅ Ti₀₋₅, sampling component 2: Nd₃₀₋₄₀Fe₅₋₂₅Pr₁₀₋₁₅Dy₁₀₋₃₀Gd₂₋₆Ho₃₋₉, sampling composition 3: Nd₃₅₋₄₅Fe₅₋₃₀Pr₁₅₋₃₀Cu₅₋₂₅Ga₀₋₃Co₀₋₅.

Example 22, after diffusion with PrGdDyCu the magnet has the following microstructure: Pr, Dy, Gd rare earth shell and transition metal shell Cu, and the formation of sampling composition 1: Nd₂₅₋₃₅Fe₂₀₋₃₀Pr₂₀₋₃₀Cu₀₋₁₀Ga₀₋₅, sampling component 2: Nd₄₅₋₅₅Fe₁₀₋₂₀Pr₂₀₋₃₀Dy₅₋₂₀Gd₄₋₁₀, sampling composition 3: Nd₄₀₋₅₅Fe₁₀₋₂₅Pr₁₅₋₄₀Cu₅₋₂₀Ga₀₋₁₀Co₀₋₅.

What claimed is:

1. A method of preparing a high temperature resistant NdFeB magnet, wherein the method comprises the following steps:
(S1) preparing NdFeB alloy flakes from a raw material of the NdFeB magnet by strip casting;
(S2) preparing a mixture of the NdFeB alloy flakes and a low melting point powder, then performing a hydrogen decrepitation of the mixture followed by jet milling to obtain a NdFeB powder, wherein the low melting point powder comprises at least one of NdCu, NdAl and NdGa;
(S3) cold isostatic pressing the alloy powder to a green compact while applying a magnetic field;
(S4) sintering the green compact to obtain a NdFeB magnet; and
(S5) applying a heavy rare earth diffusion material on the surface of the NdFeB magnet and performing a thermal diffusion process to obtain the high-temperature-resistant NdFeB magnet.

2. The method according to claim 1, wherein in step (S2) the total weight content of Cu, Al and Ga in the mixture is in the range of 0.1 to 3.0 wt %, preferably 0.4 to 1.5 wt %.

3. The method according to claim 2, wherein in step (S2) the weight content of Al in the mixture is in the range of 0.2 to 1.0 wt %, the weight content of Cu in the mixture is in the range of 0.1 to 0.5 wt %, and the weight content of Ga in the mixture is in the range of 0.05 to 0.4 wt %.

4. The method according to claim 1, wherein in step (S2), the low melting point powder has an average particle size D50 in the range of 200 nm to 4 μm.

5. The method according to claim 3, wherein in step (S1), the alloy raw material is composed of 28%≤R≤30%, 0.8%≤B≤1.2%, 0%≤M≤3% in weight percentages, the remainder is Fe, R including at least two elements of Nd, Pr, Ce, La, Tb, Dy, Ho, and Gd; and M including at least one element of Co, Mg, Ti, Zr, and Nb.

6. The method according to claim 1, wherein in step (S2), the dehydrogenation temperature is 400-600° C.

7. The method according to claim 1, wherein in step (S3), the sintering temperature is 980-1060° C. for 6-15 h.

8. The method according to claim 1, wherein in step (S3), after the sintering a primary aging treatment and secondary aging treatment is performed.

9. The method according to claim 1, wherein in step (S4), The composition of the heavy rare earth diffusion source film is R1ₓR2_{y}H_{z}M_{1-x-y-z}, wherein R1 is at least one of Nd and Pr, the weight percentage of R1 is 15%<x<50%, R2 is at least one of Ho and Gd, the weight percentage of R2 is 0%<y≤10%, H is at least one of Tb and Dy, the weight percentage of H is 40%≤z≤70%, M is at least one of Al, Cu, Ga, Ti, Co, Mg, Zn, and Sn, the weight percentage of M is 1-x-y-z.

10. The method according to claim 1, wherein in step (S5), the diffusion temperature of NdFeB magnets is 850-930° C. and the diffusion time is 6-30 h.

11. A high-temperature-resistant magnet obtained by the method according to claim 1.

12. The method according to claim 2, wherein in step (S2), the dehydrogenation temperature is 400-600° C.

13. The method according to claim 2, wherein in step (S3), the sintering temperature is 980-1060° C. for 6-15 h.

14. The method according to claim 2, wherein in step (S3), after the sintering a primary aging treatment and secondary aging treatment is performed.

15. The method according to claim 2, wherein in step (S4), The composition of the heavy rare earth diffusion source film is R1ₓR2_{y}H_{z}M_{1-x-y-z}, wherein R1 is at least one of Nd and Pr, the weight percentage of R1 is 15%<x<50%, R2 is at least one of Ho and Gd, the weight percentage of R2 is 0%<y≤10%, H is at least one of Tb and Dy, the weight percentage of H is 40%≤z≤70%, M is at least one of Al, Cu, Ga, Ti, Co, Mg, Zn, and Sn, the weight percentage of M is 1-x-y-z.

16. The method according to claim 2, wherein in step (S5), the diffusion temperature of NdFeB magnets is 850-930° C. and the diffusion time is 6-30 h.
